(19) United States
(12) Patent Application Publication
(10) Pub. No.: US 2025/0088215 A1
(43) Pub. Date: Mar. 13, 2025

(54) DISPLAY BASE PLATE AND DRIVING METHOD THEREFOR, AND DISPLAY APPARATUS

(71) Applicants: BEIJING BOE OPTOELECTRONICS TECHNOLOGY CO., LTD., Beijing (CN); BOE Technology Group Co., Ltd., Beijing (CN)

(72) Inventors: Dawei Feng, Beijing (CN); Xiaojuan Wu, Beijing (CN); Yu Zhao, Beijing (CN); Zhiqiang Yu, Beijing (CN); Feng Liu, Beijing (CN); Jiaxing Wang, Beijing (CN); Jinshuai Duan, Beijing (CN); Cuiyu Chen, Beijing (CN); Ning Wang, Beijing (CN); Danxing Hou, Beijing (CN); Jian Wang, Beijing (CN); Biqi Li, Beijing (CN)

(73) Assignees: BEIJING BOE OPTOELECTRONICS TECHNOLOGY CO., LTD., Beijing (CN); BOE Technology Group Co., Ltd., Beijing (CN)

(21) Appl. No.: 18/687,107

(22) PCT Filed: Jan. 13, 2023
(86) PCT No.: PCT/CN2023/072068

§ 371 Date: Feb. 27, 2024

(51) Int. Cl. H04B 5/22; H04B 5/43

(52) U.S. Cl. CPC H04B 5/22; H04B 5/43

(57) ABSTRACT

Disclosed are a display base plate, a driving method and a display apparatus. The display base plate includes a display area and a border area, the display area including a first display area and a second display area, and the display base plate including: a substrate, and a display signal line, a communication signal line and a compensation signal line, wherein the display signal line is configured to transmit a display signal to a pixel unit of the display area; the communication signal line is coupled with the display signal line to form a coupling capacitance, and includes a first communication signal line, at least part of the first communication signal line is located in the first display area, and the first communication signal line is configured to transmit a communication signal; and the compensation signal line is located in the border area, is connected to the first communication signal line.

### TECHNICAL FIELD

The present disclosure relates to the field of display technologies, and more particularly, to a display base plate and a driving method therefor, and a display apparatus.

### BACKGROUND

The design of a screen integrated antenna coil has the advantages of integration and light weight, which is a key research direction of the integration of a display base plate and a sensor. A coil structure is formed through a specific film layer in the display base plate, so that a screen has both a display function and a communication function, to enrich the connotation of display products and enhance the competitiveness of the display products.

### SUMMARY

The present disclosure discloses a display base plate, comprising a display area and a border area located on at least one side of the display area, the display area comprising a first display area and a second display area, and the display base plate comprising:

a substrate, and a display signal line, a communication signal line and a compensation signal line located on at least one side of the substrate, wherein the display signal line is configured to transmit a display signal to a pixel unit of the display area;

the communication signal line is coupled with the display signal line to form a coupling capacitance, and comprises a first communication signal line, at least part of the first communication signal line is located in the first display area, and the first communication signal line is configured to transmit a communication signal; and the compensation signal line is located in the border area, is connected to the first communication signal line and is configured to transmit a compensation signal to the first communication signal line, and the compensation signal is configured to suppress a voltage fluctuation on the first communication signal line caused by a display signal fluctuation on the display signal line and the coupling capacitance.

In some embodiments, the compensation signal line is independently arranged.

In some embodiments, the display base plate further comprises:
a common signal line, located in the border area and is configured to transmit a common voltage signal to a common electrode of the pixel unit, and the plurality of pixel units share the common electrode, wherein
the common signal line is multiplexed as the compensation signal line.

In some embodiments, the display base plate further comprises:
a switching circuit, located on the border area, wherein a first terminal of the switching circuit is connected to a control signal line, a second terminal of the switching circuit is connected to the first communication signal line, and a third terminal of the switching circuit is connected to the compensation signal line; and the switching circuit is configured to turn on or off the connection between the first communication signal line and the compensation signal line according to a control signal inputted by the control signal line.

In some embodiments, the switching circuit comprises:
a first transistor, wherein a control electrode is connected to the control signal line, a first electrode is connected to the compensation signal line, and a second electrode is connected to the first communication signal line.

In some embodiments, the pixel unit comprises:
a second transistor, wherein a control electrode is connected to a scanning signal line, a first electrode is connected to the display signal line, and a second electrode is connected to a pixel electrode of the pixel unit; and the second transistor is configured to control the on-off between the display signal line and the pixel electrode according to a scanning signal inputted by the scanning signal line; and
the display base plate further comprises:
a GOA circuit, located in the border area, is connected to the scanning signal line and is configured to output the scanning signal to the scanning signal line, wherein
the switching circuit is located on one side of the GOA circuit close to the display area, and the compensation signal line is located on one side of the switching circuit close to the display area.

In some embodiments, the display base plate comprises two compensation signal lines, the two compensation signal lines are a first compensation signal line and a second compensation signal line, and the first compensation signal line and the second compensation signal line are respectively located on two opposite sides of the display area in a row direction; and
among a plurality of first communication signal lines that extends in the row direction and are arranged in a column direction, the first communication signal lines located in each row are connected to the first compensation signal line and the second compensation signal line respectively.

In some embodiments, the display base plate comprises two compensation signal lines, the two compensation signal lines are a first compensation signal line and a second compensation signal line, and the first compensation signal line and the second compensation signal line are respectively located on two opposite sides of the display area in the row direction; and
among the plurality of first communication signal lines that extends in the row direction and are arranged in the column direction, the first communication signal lines located in odd-numbered rows are connected to the first compensation signal line, and the first communication signal lines located in even-numbered lines are connected to the second compensation signal line.

In some embodiments, the display base plate further comprises:
a communication signal input terminal, located on the border area, is connected to the first communication signal line and is configured to provide the communication signal to the first communication signal line, wherein
the communication signal input terminal is multiplexed as the compensation signal line.

In some embodiments, the display base plate further comprises a common signal line, located in the border area and is configured to transmit a common voltage signal to the common electrode of the pixel unit, and the plurality of pixel units share the common electrode, wherein
the communication signal line further comprises a second communication signal line, and at least part of the second communication signal line is located in the second display area; and wherein
the second communication signal line is connected to the common signal line.

The present disclosure discloses a display apparatus, comprising:
the display base plate according to any one embodiment above;
a driving circuit, configured to provide driving signals to the display base plate, the driving signals comprising the display signal, the communication signal and the compensation signal; and
a power supply circuit, configured to provide a power supply to the display base plate.

The present disclosure discloses a driving method for a displaying base plate, applied to the display base plate according to any one embodiment above, the driving method comprising:
providing a display signal to the display signal line to drive the display area to display a screen;
providing a communication signal to the first communication signal line, such that the first communication signal line transmits the communication signal; and
providing a compensation signal to the compensation signal line, such that the compensation signal is transmitted to the first communication signal line, to suppress a voltage fluctuation on the first communication signal line caused by a display signal fluctuation on the display signal line and the coupling capacitance.

In some embodiments, the compensation signal is a DC voltage stabilizing signal.

In some embodiments, the step of providing the display signal to the display signal line comprises:
in a refresh display phase, providing a refresh display signal to the display signal line to drive the display area to refresh a display screen; and
in a display holding phase, providing a display holding signal to the display signal line, such that the display area holds the display screen; and
in the cases where the display base plate further comprises a switching circuit and the switching circuit is respectively connected to a control signal line, the first communication signal line and the compensation signal line, after the step of providing the compensation signal to the compensation signal line, the driving method further comprises:
in a first turn-on phase, providing a turn-on signal to the control signal line, such that the switching circuit turns on the connection between the first communication signal line and the compensation signal line; and
in a first turn-off phase, providing a turn-off signal to the control signal line, such that the switching circuit turns off the connection between the first communication signal line and the compensation signal line, wherein
the first turn-on phase comprises: a refresh display phase in a non-communicated state, and a start-end period of the display holding phase in the non-communicated state; and
the first turn-off phase comprises: an intermediate period of the display holding phase in the non-communicated state, a refresh display phase in a communicated state, and a display holding phase in the communicated state.

In some embodiments, he compensation signal is an AC signal, and the AC signal is opposite in phase to the voltage fluctuation.

In some embodiments, the AC signal is equal in amplitude to the voltage fluctuation.

In some embodiments, a frequency of the compensation signal is less than or equal to a scanning frequency of the display base plate, and the scanning frequency is a product of a frame refresh frequency of the display base plate and a number of rows of scanning signal lines in the display base plate.

In some embodiments, the step of providing the display signal to the display signal line comprises:
in a refresh display phase, providing a refresh display signal to the display signal line to drive the display area to refresh a display screen; and
in a display holding phase, providing a display holding signal to the display signal line, such that the display area holds the display screen; and
in the cases where the display base plate further comprises a switching circuit and the switching circuit is respectively connected to a control signal line, the first communication signal line and the compensation signal line, after the step of providing the compensation signal to the compensation signal line, the driving method further comprises:
in a second turn-on phase, providing a turn-on signal to the control signal line, such that the switching circuit turns on the connection between the first communication signal line and the compensation signal line; and
in a second turn-off phase, providing a turn-off signal to the control signal line, such that the switching circuit turns off the connection between the first communication signal line and the compensation signal line, wherein
the second turn-on phase comprises a start-end period of the refresh display phase and the display holding phase; and
the second turn-off phase comprises: an intermediate period of the display holding phase.

In some embodiments, the communication signal comprises a high-frequency signal, a frequency of the high-frequency signal is greater than a scanning frequency of the display base plate, and the scanning frequency is a product of a frame refresh frequency of the display base plate and a number of rows of scanning signal lines in the display base plate.

In some embodiments, the step of providing the display signal to the display signal line comprises:
in a refresh display phase, providing a refresh display signal to the display signal line to drive the display area to refresh a display screen; and
in a display holding phase, providing a display holding signal to the display signal line, such that the display area holds the display screen; and
the step of providing the communication signal to the first communication signal line comprises:
in the refresh display phase and the display holding phase, providing the high-frequency signal to the first communication signal line; or
in the intermediate period of the display holding phase in the non-communicated state, the refresh display phase in the communicated state, and the display holding phase in the communicated state, providing the high-frequency signal to the first communication signal line.

The above description is only an overview of the technical solution of the present disclosure, and in order to be able to understand more clearly the technical means of the present disclosure, it can be implemented in accordance with the contents of the description, and in order to make the above and other purposes, features and advantages of the present disclosure more obvious and easy to understand, the specific embodiment of the present disclosure is listed below.

### BRIEF DESCRIPTION OF THE DRAWINGS

To describe the technical solutions in the embodiments or the related art of the present disclosure more clearly, the following briefly introduces the accompanying drawings required for describing the embodiments or the related art. Apparently, the accompanying drawings in the following description show merely some embodiments of the present disclosure, and a person of ordinary skill in the art may still derive other drawings from these accompanying drawings without creative efforts. It should be noted that the scales in the drawings are for illustration only and do not represent actual scales.

FIG. 1 shows a schematic diagram of a planar structure of a display base plate provided by the present disclosure;

FIG. 2 shows a schematic diagram of a connecting structure of a first display base plate provided by the present disclosure;

FIG. 3 shows a schematic diagram of a connecting structure of a second display base plate provided by the present disclosure;

FIG. 4a shows a schematic diagram of a connecting structure of a third display base plate provided by the present disclosure;

FIG. 4b shows a schematic diagram of a connecting structure of a fourth display base plate provided by the present disclosure;

FIG. 5 shows a schematic diagram of a connecting structure of a fifth display base plate provided by the present disclosure;

FIG. 6 shows a schematic sectional view and a planar layout of a display base plate provided by the present disclosure;

FIG. 7 shows a schematic sectional view and a planar layout of another display base plate provided by the present disclosure;

FIG. 8 shows a planar layout of a display base plate provided by the present disclosure at an interface between a display area and a border area;

FIG. 9 shows a timing diagram of driving signals of the first display base plate provided by the present disclosure;

FIG. 10 shows a timing diagram of driving signals of the second display base plate provided by the present disclosure;

FIG. 11 shows a timing diagram of driving signals of the third display base plate provided by the present disclosure;

FIG. 12 shows a timing diagram of driving signals of the fourth display base plate provided by the present disclosure; and

FIG. 13 shows a schematic diagram of a connecting structure of a GOA circuit provided by the present disclosure.

### DETAILED DESCRIPTION OF THE EMBODIMENTS

In order to make the objectives, technical solutions and advantages of the embodiments of the present disclosure more clearly, the technical solutions in the embodiments of the present disclosure will be described clearly and completely in conjunction with the accompanying drawings in the embodiments of the present disclosure. Apparently, the described embodiments are merely some embodiments, rather than all embodiments, of the present disclosure. Based on the embodiments of the present disclosure, all other embodiments derived by a person of ordinary skill in the art without creative efforts shall fall within the protection scope of the present disclosure.

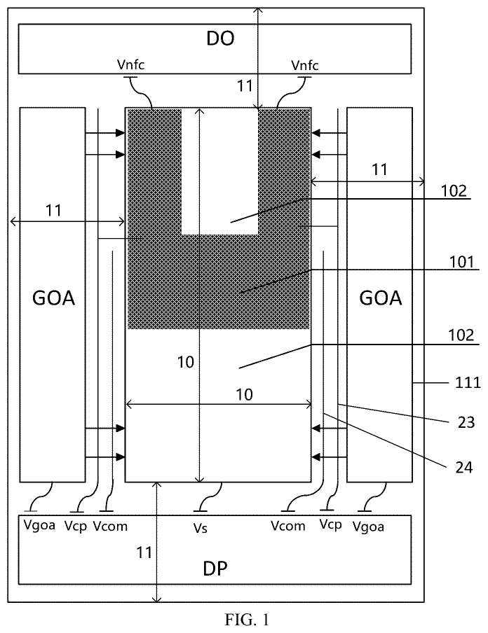

The present disclosure provides a display base plate. Referring to FIG. 1, a schematic diagram of a planar structure of this display base plate is shown. As shown in FIG. 1, this display base plate includes a display area 10 and a border area 11 located on at least one side of the display area 10, the display area 10 including a first display area 101 and a second display area 102.

The border area 11 may be located on one side, both sides, three sides, or four sides of the display area 10 (as shown in FIG. 1), which will not be limited in the present disclosure.

During specific implementation, the display area 10 may include one or more first display areas 101 and one or more second display areas 102. In FIG. 1, the display area 10 includes a first display area 101 and two second display areas 102. The two second display areas 102 are located on both sides of the first display area 101 respectively.

Exemplarily, as shown in FIG. 1, the first display area 101 is U-shaped. The U-shaped first display area 101 may form a closed coil with a circuit located on a printed circuit board, which facilitates improving the sensitivity of the coil.

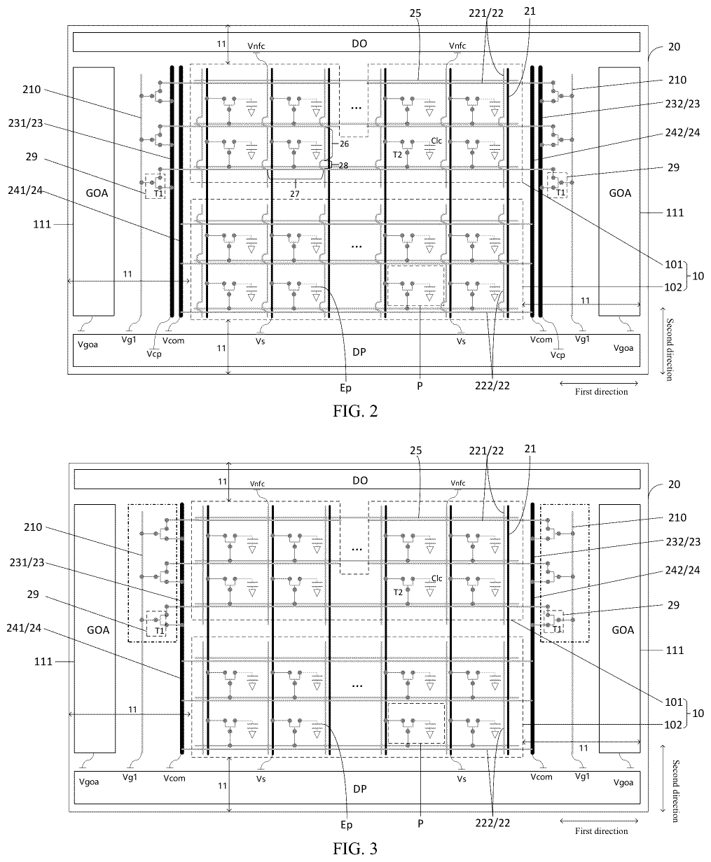

As shown in any one of FIG. 2 to FIG. 5, this display base plate includes a substrate 20, and a display signal line 21, a communication signal line 22 and a compensation signal line 23 located on at least one side of the substrate 20.

As shown in any one of FIG. 2 to FIG. 5, the display signal line 21 is configured to transmit a display signal to a pixel unit P in the display area 10. Exemplarily, the display signal line 21 may be connected to a display signal input terminal Vs located in the border area 11 (a DP side as shown). The display signal input terminal Vs is configured to provide a display signal to the display signal line 21.

As shown in any one of FIG. 2 to FIG. 5, the communication signal line 22 is coupled with the display signal line 21 to form a coupling capacitance. The communication signal line 22 includes a first communication signal line 221. At least part of the first communication signal line 221 is located in the first display area 101. The first communication signal line 221 is configured to transmit a communication signal. Therefore, the first display area 101 has functions such as Near Field Communication (NFC). Exemplarily, the first communication signal line 221 may be connected to a communication signal input terminal Vnfc located in the border area 11 (a DO side as shown). The communication signal input terminal Vnfc is configured to provide a communication signal to the first communication signal line 221.

As shown in any one of FIG. 2 to FIG. 5, the compensation signal line 23 is located in the border area 11, is connected to the first communication signal line 221 and is configured to transmit a compensation signal to the first communication signal line 221. The compensation signal is configured to suppress a voltage fluctuation on the first communication signal line 221 caused by a display signal fluctuation on the display signal line 21 and the coupling capacitance. Exemplarily, the compensation signal line 23 may be connected to a compensation signal input terminal Vcp located in the border area 11 (a DP side as shown). The compensation signal input terminal Vcp is configured to provide a compensation signal to the compensation signal line 23.

During specific implementation, a display signal may be provided to the display signal line 21 to drive the display area 10 display a screen; a communication signal may be provided to the first communication signal line 221, such that the first communication signal line 221 transmits a communication signal; and a compensation signal may be provided to the compensation signal line 23, such that the compensation signal is transmitted to the first communication signal line 221, to suppress a voltage fluctuation on the first communication signal line 221 caused by the display signal fluctuation on the display signal line 21 and the coupling capacitance.

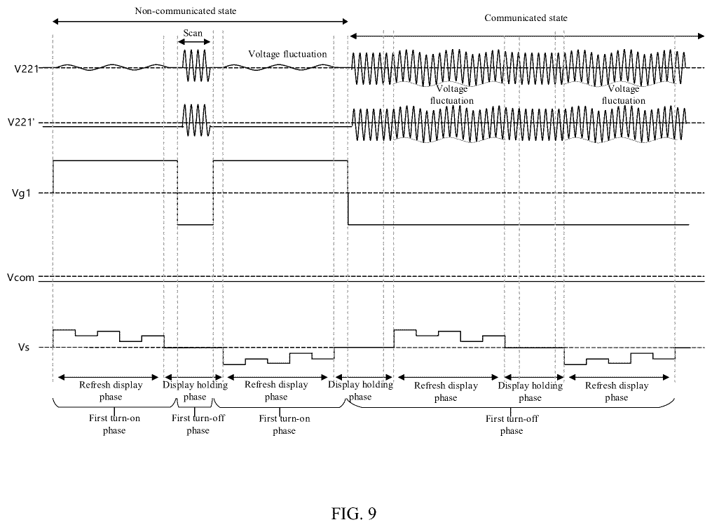

In the process of displaying the screen in the first display area 101, because the display signal on the display signal line 21 (as shown in Vs in FIG. 9 to FIG. 12) is constantly changing, and because of the existence of the coupling capacitance between the display signal line 21 and the first communication signal line 221, the communication signal on the first communication signal line 221 may be superimposed with a low-frequency voltage fluctuation (as shown in V221 in FIG. 9 to FIG. 12, V211 being a voltage signal that is not compensated by a compensation signal on the first communication signal line 221).

According to a principle of capacitive coupling, and considering the influence of a primary coupling capacitance, the voltage fluctuation ΔVn on the first communication signal line 221 may be calculated as:

$$Δ Vn = ( V 2 - V 1 ) * {C}_{ns} / ( {C}_{ns} + {C}_{np} + {C}_{nc} ) ,$$

in which, V1 is an initial voltage on the display signal line 21; V2 is a changed voltage

on the display signal line 21; Cₙₛ is a coupling capacitance between the display signal line 21 and the communication signal line 22; Cₙₚ is a coupling capacitance between a pixel electrode Ep and the communication signal line 22; and C_{nc} is a coupling capacitance between a common electrode Ec and the communication signal line 22. A voltage difference between the common electrode Ec and the pixel electrode Ep may drive the deflection of liquid crystal molecules at a corresponding position, thereby controlling the transmittance at that position. A plurality of pixel units P located in the display area 10 may share the common electrode Ec.

In the presence of the coupling capacitance Cₙₚ between the pixel electrode Ep and the communication signal line 22, the voltage fluctuation ΔVn on the first communication signal line 221 causes a voltage fluctuation on the pixel electrode Ep. According to the voltage fluctuation ΔVn on the first communication signal line 221, the voltage fluctuation ΔVp on the pixel electrode Ep may be calculated as:

$$Δ Vp = Δ Vn * {C}_{np} / ( {C}_{np} + {C}_{pc} ) ,$$

in which, C_{pc} is the coupling capacitance between the common electrode Ec and the pixel electrode Ep. The inventors tested a 5.65-inch display base plate and measured the voltage fluctuation ΔVn on the first communication signal line 221 to be about 0.5 V.

When the voltage fluctuation ΔVp on the pixel electrode Ep exceeds a defined value, display grayscales of the first display area 101 and the second display area 102 may be inconsistent under a specific screen, resulting in the first display area 101 being visually visible.

According to the display base plate provided by the present disclosure, by arranging the compensation signal line 23 in the border area 11, the compensation signal line 23 provides a compensation signal to the first communication signal line 221 that can suppress the voltage fluctuation caused by the display signal fluctuation and the coupling capacitance, thereby reducing or eliminating the voltage fluctuation on the pixel electrode Ep (as shown in V221′ in FIG. 9 to FIG. 12, V211′ being a voltage signal on the first communication signal line 221 that is compensated by the compensation signal), reducing a display difference between the first display area 101 and the second display area 102, and improving the display uniformity of the display area 10.

During specific implementation, the first communication signal line 221 and the compensation signal line 23 may be arranged on the same layer or on different layers, which will not be limited in the present disclosure.

In some implementations, as shown in any one of FIG. 2 to FIG. 5, the display base plate further includes a common signal line 24, located in the border area 11 and is configured to transmit a common voltage signal to the common electrode Ec of the pixel unit P, and the plurality of pixel units P share the common electrode Ec. The communication signal line 22 further includes a second communication signal line 222, and at least part of the second communication signal line 222 is located in the second display area 102. The second communication signal line 222 is connected to the common signal line 24.

Exemplarily, the common signal line 24 may be connected to a common signal input terminal Vcom located in the border area 11 (a DP side as shown). The common signal input terminal Vcom is configured to provide a common voltage signal to the common signal line 24.

Since the common electrode Ec is distributed on the entire surface and the common voltage signal generally has a constant value (e.g., a value between 0 and −2V), even if there is a coupling capacitance between the second communication signal line 222 and the display signal line 21, a voltage on the second communication signal line 222 is also difficult to be pulled by a display signal, such that the voltages of the second communication signal line 222 and the pixel electrode Ep can be ensured to be stable, thereby ensuring a stable display effect of the second display area 102.

During specific implementation, the second communication signal line 222 and the common signal line 24 may be arranged on the same layer or on different layers, which will not be limited in the present disclosure.

As shown in any one of FIG. 2 to FIG. 5, in the display area 10, a plurality of communication signal lines 22 may be intersected with each other to form a grid structure, and the intersected communication signal lines 22 are connected with each other at the intersection positions.

In some implementations, as shown in FIG. 2, the compensation signal line 23 is independently arranged (as shown in FIG. 2). In this implementation, the compensation signal line 23 is arranged independently of other signal lines (e.g., the common signal line 24), which facilitates keeping signals on other signal lines (e.g., the common signal line 24) stable.

In the actual driving process, a compensation signal that is opposite in phase, but equal in amplitude to the voltage fluctuation A Vn on the first communication signal line 221 may be provided to the compensation signal line 23.

In some implementations, as shown in FIG. 3, the common signal line 24 is multiplexed as the compensation signal line 23. Correspondingly, the common voltage signal on the common signal line 24 is multiplexed as the compensation signal.

By multiplexing the common signal line 24 as the compensation signal line 23, that is, the first communication signal line 221 is connected to the common signal line 24, because the common voltage signal transmitted on the common signal line 24 generally has a constant value, the voltage on the first communication signal line 221 is difficult to be pulled by the display signal. Therefore, the voltages of the first communication signal line 221 and the pixel electrode Ep can be ensured to be stable, thereby ensuring a stable display effect of the first display area 101.

In addition, in FIG. 3, since the first communication signal line 221 and the second communication signal line 222 are both connected to the common signal line 24, a display difference between the first display area 101 and the second display area 102 can be minimized in this way, and the display uniformity of the display area 10 is further improved.

In addition, by multiplexing the common signal line 24 as the compensation signal line 23, the compensation signal line 23 does not need to be additionally arranged, so that a space of the border area 11 can be saved, which facilitates achieving a narrow border.

During specific implementation, the compensation signal line 23 may be directly connected to the first communication signal line 221, both of which are always in a communicated state; and a switching circuit may also be arranged between the compensation signal line 23 and the first communication signal line 221 to control them to be turned on or off.

In some implementations, as shown in FIG. 2 or FIG. 3, the display base plate further includes: a switching circuit 29, located on the border area 11 and includes a first terminal, a second terminal and a third terminal, wherein the first terminal is connected to the control signal line 210, the second terminal is connected to the first communication signal line 221, and the third terminal is connected to the compensation signal line 23. The switching circuit is configured to turn on or off the connection between the first communication signal line 221 and the compensation signal line 23 according to a control signal inputted by the control signal line 210.

By arranging the switching circuit 29 and matching specific control signal timing, the first communication signal line 221 and the compensation signal line 23 can be controlled to be turned on and off in a time-sharing manner, such that the visible time of the first display area 101 is greatly shortened, and a normal communication function of the first display area 101 is achieved while a display effect of the display area 10 is improved.

During specific implementation, one switching circuit 29 may be connected to one or more first communication signal lines 221, which will not be limited in the present disclosure.

In some implementations, as shown in FIG. 2 and FIG. 3, the switching circuit 29 includes a first transistor T1, wherein a control electrode of the first transistor T1 (i.e., the first terminal of the switching circuit 29) is connected to the control signal line 210, a first electrode of the first transistor T1 (i.e., the third terminal of the switching circuit 29) is connected to the compensation signal line 23, and a second electrode of the first transistor T1 (i.e., the second terminal of the switching circuit 29) is connected to the first communication signal line 221.

The first transistor T1 may be an N-type transistor or a P-type transistor, etc., which will not be limited in the present disclosure.

In some implementations, as shown in FIG. 2 or FIG. 3, the pixel unit P includes a second transistor T2, wherein a control electrode of the second transistor T2 is connected to the scanning signal line 25, a first electrode of the second transistor T2 is connected to the display signal line 21, and a second electrode of the second transistor T2 is connected to the pixel electrode Ep of the pixel unit P. The second transistor is configured to control the on-off between the display signal line 21 and the pixel electrode Ep according to a scanning signal inputted by the scanning signal line 25. The display base plate further includes a GOA circuit 111, located in the border area 11, is connected to the scanning signal line 25 and is configured to output the scanning signal to the scanning signal line 25. The switching circuit 29 is located in the border area 11 and is located on one side of the GOA circuit 111 close to the display area 10. The compensation signal line 23 may be located on one side of the switching circuit 29 close to the display area 10 (as shown in FIG. 2 and FIG. 3) or on one side of the switching circuit 29 close to the GOA circuit 111.

Referring to FIG. 8, a design layout of the display base plate at an interface between the display area and the border area is shown. In FIG. 2 or FIG. 8, the common signal line 24, the compensation signal line 23, the switching circuit 29 and the control signal line 210 are arranged between the display area 10 and the GOA circuit 111 in sequence. The common signal line 24 is arranged close to the display area 10, and the control signal line 210 is arranged close to the GOA circuit 111.

In FIG. 3, the common signal line 24 and the compensation signal line 23 share one signal line; and the common signal line 24, the switching circuit 29 and the control signal line 210 are arranged between the display area 10 and the GOA circuit 111 in sequence. The common signal line 24 is arranged close to the display area 10, and the control signal line 210 is arranged close to the GOA circuit 111.

Exemplarily, as shown in FIG. 2 or FIG. 3, the GOA circuit 111 may be connected to a gate drive signal input terminal Vgoa located in the border area 11 (a DP side as shown). The gate drive signal input terminal Vgoa is configured to provide a gate drive signal to the GOA circuit 111.

The second transistor T2 may be an N-type transistor or a P-type transistor, etc., which will not be limited in the present disclosure. The first transistor T1 and the second transistor T2 may be formed synchronously.

In some implementations, as shown in any one of FIG. 2 to FIG. 4a, the compensation signal line 23 is arranged on both sides of the display base plate, that is, the compensation signal line 23 is arranged on both sides of the display area 10. Exemplarily, the display base plate includes two compensation signal lines 23. The two compensation signal lines 23 are a first compensation signal line 231 and the second compensation signal line 232, and the first compensation signal line 231 and the second compensation signal line 232 are respectively located on two opposite sides (a left side and a right side of the display area 10 in FIG. 2 to FIG. 4a) of the display area 10 in a row direction.

In some implementations, as shown in FIG. 2 or FIG. 3, among a plurality of first communication signal lines 221 that extends in the row direction and are arranged in a column direction, the first communication signal lines 221 located in each row are connected to the first compensation signal line 231 and the second compensation signal line 232 respectively. That is, the first communication signal lines 221 located in each row are connected to the first compensation signal line 231 and the second compensation signal line 232 at the same time.

In FIG. 2 or FIG. 3, the first communication signal line 221 is connected to the compensation signal line 23 through the switching circuit 29, and the switching circuit 29 includes the first transistor T1. In the border area 11 located on the left side of the display area 10, the first electrode of the first transistor T1 is connected to the first compensation signal line 231, the second electrode is connected to the first communication signal line 221 of the corresponding row, and the control electrode is connected to the control signal line 210 on the left side; and in the border area 11 located on the right side of the display area 10, the first electrode of the first transistor T1 is connected to the second compensation signal line 232, the second electrode is connected to the first communication signal line 221 of the corresponding row, and the control electrode is connected to the control signal line 210 on the right side.

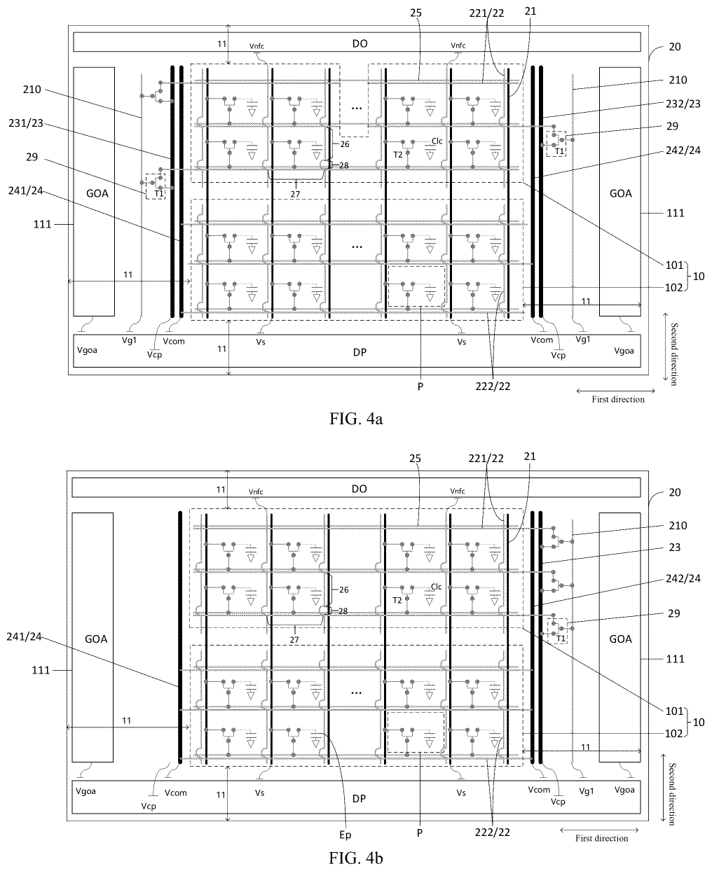

In order to make reasonable use of a space of the border area 11, as shown in FIG. 4a or FIG. 8, among the plurality of first communication signal lines 221 that extends in the row direction and are arranged in the column direction, the first communication signal lines 221 located in odd-numbered rows (e.g., an odd number 221 as shown in FIG. 8) are connected to the first compensation signal line 231, and the first communication signal lines 221 located in even-numbered lines (e.g., an even number 221 as shown in FIG. 8) are connected to the second compensation signal line 232.

In FIG. 4a, the first communication signal line 221 is connected to the compensation signal line 23 through the switching circuit 29, and the switching circuit 29 includes the first transistor T1. In the border area 11 located on the left side of the display area 10, the first electrode of the first transistor T1 is connected to the first compensation signal line 231, the second electrode is connected to the first communication signal line 221 of the odd-numbered row, and the control electrode is connected to the control signal line 210 on the left side; and in the border area 11 located on the right side of the display area 10, the first electrode of the first transistor T1 is connected to the second compensation signal line 232, the second electrode is connected to the first communication signal line 221 of the even-numbered row, and the control electrode is connected to the control signal line 210 on the right side.

In some implementations, the compensation signal line 23 is arranged on a single side of the display base plate, that is, the compensation signal line 23 is arranged on one side of the display area 10. Exemplarily, as shown in FIG. 4b, the display base plate includes a compensation signal line 23, located on the right side of the display area 10.

As shown in FIG. 4b, among the plurality of first communication signal lines 221 that extends in the row direction and are arranged in the column direction, the first communication signal lines 221 located in each row are connected to the compensation signal line 23 respectively. The first communication signal line 221 is connected to the compensation signal line 23 through the switching circuit 29, and the switching circuit 29 includes the first transistor T1. In the border area 11 located on the right side of the display area 10, the first electrode of the first transistor T1 is connected to the compensation signal line 23, the second electrode is connected to the first communication signal line 221 of the corresponding row, and the control electrode is connected to the control signal line 210.

In some implementations, as shown in any one of FIG. 2 to FIG. 4a, the display base plate includes two common signal lines 24. The two common signal lines 24 are a first common signal line 241 and a second common signal line 242 respectively, and the first common signal line 241 and the second common signal line 242 are respectively located on two opposite sides (a left side and a right side of the display area 10 in FIG. 2 to FIG. 4a) of the display area 10 in the row direction.

In some implementations, as shown in FIG. 2 or FIG. 3, among the plurality of second communication signal lines 222 that extends in the row direction and are arranged in the column direction, the second communication signal lines 222 located in each row are connected to the first common signal line 241 and the second common signal line 242 respectively. That is, the second communication signal lines 222 in each row are connected to the first common signal line 241 and the second common signal line 242 at the same time.

In order to make reasonable use of the space of the border area 11, as shown in FIG. 4a, among the plurality of second communication signal lines 222 that extends in the row direction and are arranged in the column direction, the second communication signal lines 222 located in odd-numbered rows (e.g., an odd number 222 as shown in FIG. 8) are connected to the first common signal line 241, and the second communication signal lines 222 located in even-numbered lines (e.g., an even number 222 as shown in FIG. 8) are connected to the second common signal line 242.

In order to increase an opening rate, in some implementations, as shown in FIG. 2, the communication signal line 22 has a first extension 26. An extension direction of the first extension 26 is parallel to an extension direction of the display signal line 21. In addition, in a first direction, an orthographic projection of the first extension 26 on the substrate 20 overlaps at least partially with an orthographic projection of the display signal line 21 on the substrate 20. The first direction is perpendicular to the extension direction of the display signal line 21.

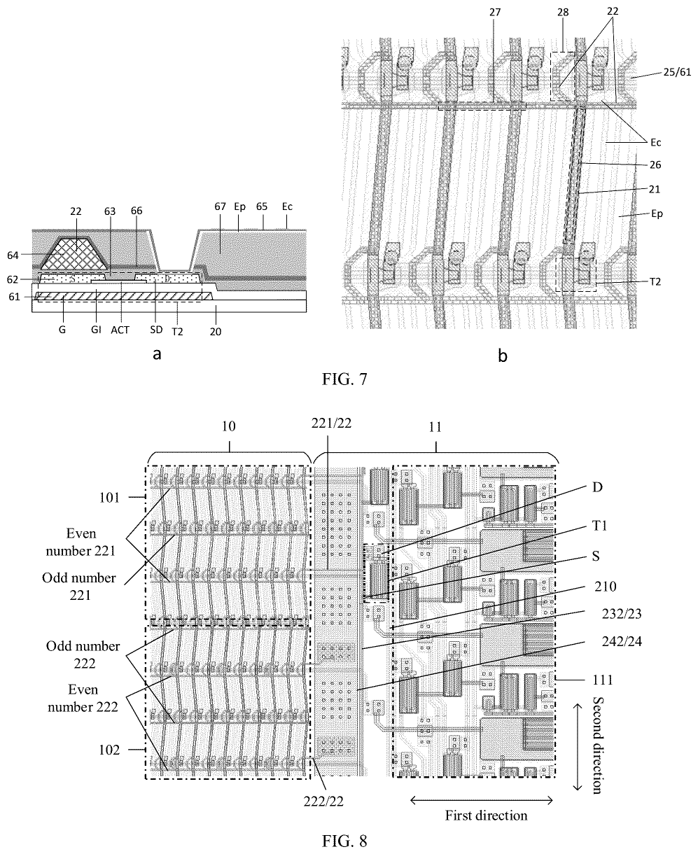

The orthographic projection of the first extension 26 on the substrate 20 overlaps at least partially with the orthographic projection of the display signal line 21 on the substrate 20, including: the orthographic projection of the first extension 26 on the substrate 20 covers the orthographic projection of the display signal line 21 on the substrate 20, or the orthographic projection of the display signal line 21 on the substrate 20 covers the orthographic projection of the first extension 26 on the substrate 20 (as shown in FIG. 6 and FIG. 7), or the orthographic projection of the first extension 26 on the substrate 20 overlaps completely with the orthographic projection of the display signal line 21 on the substrate 20.

FIG. 6a shows a schematic local sectional view of a display base plate in a display area; and FIG. 6b shows a schematic local planar view of the display base plate in the display area. FIG. 7a shows a schematic local sectional view of another display base plate in a display area; and FIG. 7b shows a schematic local planar view of the display base plate in the display area.

In order to increase the opening rate, in some implementations, as shown in FIG. 2, the display base plate further includes a scanning signal line 25. The scanning signal line 25 is configured to transmit a scanning signal to the pixel unit P. The communication signal line 22 has a second extension 27. An extension direction of the second extension 27 is parallel to an extension direction of the scanning signal line 25. In a second direction, an orthographic projection of the second extension 27 on the substrate 20 overlaps at least partially with an orthographic projection of the scanning signal line 25 on the substrate 20. The second direction is perpendicular to the extension direction of the scanning signal line 25.

The orthographic projection of the second extension 27 on the substrate 20 overlaps at least partially with the orthographic projection of the scanning signal line 25 on the substrate 20, including: the orthographic projection of the second extension 27 on the substrate 20 covers the orthographic projection of the scanning signal line 25 on the substrate 20, or the orthographic projection of the scanning signal line 25 on the substrate 20 covers the orthographic projection of the second extension 27 on the substrate 20, or the orthographic projection of the second extension 27 on the substrate 20 overlaps completely with the orthographic projection of the scanning signal line 25 on the substrate 20.

The first direction is intersected with the second direction. Exemplarily, in FIG. 2, the first direction and the second direction are perpendicular to each other. The first direction is the extension direction (e.g., the row direction) of the scanning signal line 25, and the second direction is the extension direction (e.g., the column direction) of the display signal line 21.

It should be noted that, in the first direction, the orthographic projection of the first extension 26 on the substrate 20 may have no overlap with the orthographic projection of the display signal line 21 on the substrate 20. In the second direction, the orthographic projection of the second extension 27 on the substrate 20 may have no overlap with the orthographic projection of the scanning signal line 25 on the substrate 20 (as shown in FIG. 6 and FIG. 7). In order to visually show the communication signal line 22, the scanning signal line 25 and the display signal line 21, the communication signal line 22 shown in FIG. 2 to FIG. 5 is displayed in a non-overlapping mode with the scanning signal line 25 and the display signal line 21 respectively.

In some implementations, as shown in FIG. 2, the communication signal line 22 has a bending portion 28. The bending portion 28 is configured to make way for the second transistor T2 in the pixel unit P. In this way, the problem of film layer breakage that may be caused by too large thickness of a film layer at the second transistor T2 can be avoided, and a spacer may be placed at the second transistor T2. The spacer is configured to support a box thickness of a liquid crystal display base plate. The bending portion 28 may be arranged to prevent the box thickness at the second transistor T2 from being too large, thereby causing the problem of uneven display.

The bending portion 28 may be connected between two adjacent first extensions 26 (as shown in FIG. 2) or between two adjacent second extensions 27, which will not be limited in the present disclosure.

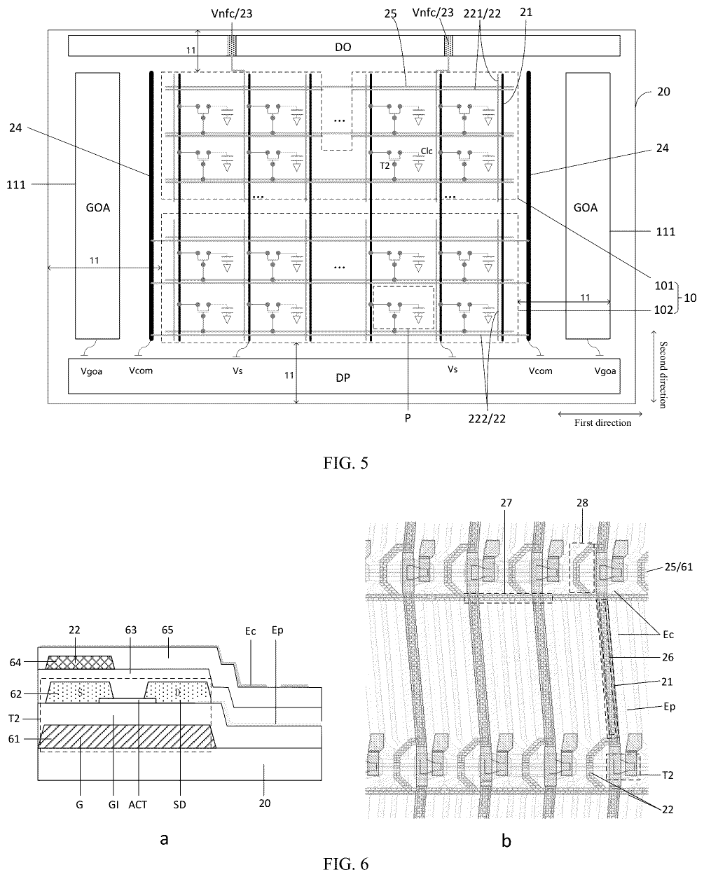

In some implementations, as shown in FIG. 5, the display base plate further includes a communication signal input terminal Vnfc, located on the border area 11, is connected to the first communication signal line 221 and is configured to provide the communication signal to the first communication signal line 221. The communication signal input terminal Vnfc is multiplexed as the compensation signal line 23.

During specific implementation, a superimposed signal of the compensation signal and the communication signal may be provided to the communication signal input terminal Vnfc. The communication signal input terminal Vnfc transmits the compensation signal and the communication signal to the first communication signal line 221. The compensation signal may suppress a communication signal fluctuation caused by a display signal fluctuation and a coupling capacitance of the display signal line 21 on the first communication signal line 221, thereby avoiding a voltage fluctuation on the pixel electrode Ep, reducing a display difference between the first display area 101 and the second display area 102, and improving the display uniformity of the display area 10.

By multiplexing the communication signal input terminal Vnfc as the compensation signal line 23, on the one hand, the wiring can be reduced, thereby saving a space of the border area and helping to realize a narrow border; and on the other hand, a common voltage signal fluctuation caused by the communication between the first communication signal line 221 and the common signal line 24 can be avoided, in order to ensure that an electric field between the common electrode Ec and the pixel electrode Ep is stable, and liquid crystal molecules cannot change rhythmically in orientation, thereby ensuring a stable display effect of the display area.

In some implementations, as shown in FIG. 6 and FIG. 7, the first transistor T1 and the second transistor T2 include a gate G, a gate insulation layer GI, an active layer ACT and a source-drain SD which are laminated in sequence, wherein the gate G is arranged close to the substrate 20, and the source-drain SD includes a source S and a drain D. One of the first and second electrodes is the source S, the other is the drain D, and the control electrode is the gate G.

In some implementations, the display base plate provided by the present disclosure may be prepared by a 7Mask process. Referring to FIG. 6, the 7Mask process includes seven patterning processes, which may specifically include the following steps:

Step S01: preparing a first metal layer 61 on the substrate 20 by adopting a first patterning process, wherein the first metal layer 61 may include a gate G, a scanning signal line 25 and a control signal line 210, the scanning signal line 25 is interconnected with the gate G of the second transistor T2, and the control signal line 210 is interconnected with the gate G in the first transistor T1;

Step S02: preparing a gate insulation layer GI on one side of the first metal layer 61 away from the substrate 20;

Step S03: preparing an active layer ACT on one side of the gate insulation layer GI away from the substrate 20 by using a second patterning process;

Step S04: preparing a pixel electrode Ep on one side of the active layer ACT away from the substrate 20 by using a third patterning process;

Step S05: preparing a second metal layer 62 on one side of the pixel electrode Ep away from the substrate 20 by adopting a fourth patterning process, wherein the second metal layer 62 may include a source-drain SD, a display signal line 21, a compensation signal line 23 and a common signal line 24, the display signal line 21 is interconnected with the first electrode of the second transistor T2, the second electrode of the second transistor T2 is interconnected with the pixel electrode Ep, and the compensation signal line 23 is interconnected with the first electrode of the first transistor T1;

Step S06: preparing a first passivation layer 63 on one side of the second metal layer 62

away from the substrate 20;

Step S07: preparing a third metal layer 64 on one side of the first passivation layer 63 away from the substrate 20 by using a fifth patterning process, wherein the third metal layer 64 may include a first communication signal line 221 and a second communication signal line 222, the first communication signal line 221 extends to the border area 11 and is connected to the second electrode of the first transistor T1 through a via hole, and the second communication signal line 222 extends to the border area 11 and is connected to the common signal line 24 through a via hole;

Step S08: preparing a second passivation layer 65 on one side of the third metal layer 64 away from the substrate 20 by adopting a sixth patterning process, and forming a via hole in the second passivation layer 65; and

Step S09: preparing a common electrode Ec on one side of the second passivation layer 65 away from the substrate 20 by using a seventh patterning process, wherein the common electrode Ec extends to the border area 11 and is connected to the common signal line 24 through a via hole.

The display base plate prepared by the 7Mask process is shown in FIG. 6, wherein the thickness of the communication signal line 22 (e.g., a copper wire) may be greater than or equal to 5000 Å and less than or equal to 12000 Å, for example, may be 9000 Å.

In some implementations, the display base plate provided by the present disclosure may be prepared by a 9Mask process. Referring to FIG. 7, the 9Mask process includes nine patterning processes, which may specifically include the following steps:

Step S11: preparing a first metal layer 61 on the substrate 20 by adopting a first patterning process, wherein the first metal layer 61 may include a gate G, a scanning signal line 25 and a control signal line 210, the scanning signal line 25 is interconnected with the gate G of the second transistor T2, and the control signal line 210 is interconnected with the gate G of the first transistor T1;

Step S12: preparing a gate insulation layer GI on one side of the first metal layer 61 away from the substrate 20;

Step S13: preparing an active layer ACT on one side of the gate insulation layer GI away from the substrate 20 by using a second patterning process;

Step S14: preparing a second metal layer 62 on one side of the active layer ACT away from the substrate 20 by adopting a third patterning process, wherein the second metal layer 62 may include a source-drain SD, a display signal line 21, a compensation signal line 23 and a common signal line 24, the display signal line 21 is interconnected with the first electrode of the second transistor T2, and the compensation signal line 23 is interconnected with the first electrode of the first transistor T1;

Step S15: preparing a first passivation layer 63 on one side of the second metal layer 62 away from the substrate 20;

Step S16: preparing a third metal layer 64 on one side of the first passivation layer 63

away from the substrate 20 by using a fourth patterning process, wherein the third metal layer 64 may include a first communication signal line 221 and a second communication signal line 222, the first communication signal line 221 extends to the border area 11 and is connected to the second electrode of the first transistor T1 through a via hole, and the second communication signal line 222 extends to the border area 11 and is connected to the common signal line 24 through a via hole;

Step S17: forming a via hole in the first passivation layer 63 by adopting a fifth patterning process;

Step S18: preparing a buffer layer 66 on one side of the third metal layer 64 away from the substrate 20;

Step S19: preparing a flat layer 67 on one side of the buffer layer 66 away from the substrate 20 by adopting a sixth patterning process, and forming a via hole in the flat layer 67;

Step S20: preparing a pixel electrode Ep on one side of the flat layer 67 away from the substrate 20 by using a seventh patterning process, wherein the pixel electrode Ep is connected to the second electrode of the second transistor T2 through a via hole;

Step S110: preparing a second passivation layer 65 on one side of the pixel electrode Ep away from the substrate 20 by adopting an eighth patterning process, and forming a via hole in the second passivation layer 65; and

Step S111: preparing a common electrode Ec on one side of the second passivation layer 65 away from the substrate 20 by using a ninth patterning process, wherein the common electrode Ec extends to the border area 11 and is connected to the common signal line 24 through a via hole.

The display base plate prepared by the 9Mask process is shown in FIG. 7, wherein the thickness of the communication signal line 22 (e.g., a copper wire) may be greater than or equal to 15000 Å and less than or equal to 25000 Å, for example, may be 20000 Å. Compared with the 7Mask process, the 9Mask process may be used to prepare a communication signal line 22 with a larger thickness.

During specific implementation, the pixel electrode Ep and the common electrode Ec may be made of a transparent conductive material, such as indium tin oxide, which will not be limited in the present disclosure. The first metal layer 61, the second metal layer 62 and the third metal layer 64 may be made of a metallic material such as copper, aluminum, molybdenum, magnesium, or silver.

The following describes several specific implementations of the display base plate. In the first implementation, as shown in FIG. 3, the common signal line 24 is

multiplexed as the compensation signal line 23. That is, the compensation signal, namely the common voltage signal, is a DC voltage stabilizing signal. In this implementation, a switching circuit 29 is arranged between the first communication signal line 221 and the compensation signal line 23, and the switching circuit 29 controls the on-off between the first communication signal line 221 and the compensation signal line 23.

Referring to FIG. 9, a timing diagram of various signals in the first implementation is shown. This timing diagram is shown by taking the first transistor T1 being an N-type transistor as an example. V211 is a voltage signal that is not compensated by a compensation signal on the first communication signal line 221; V211′ is a voltage signal that is compensated by the compensation signal on the first communication signal line 221; Vgl is a control signal on the control signal line 210; Vcom is a common voltage signal on the common signal line 24; and Vs is a display signal on the display signal line 21.

As shown in FIG. 9, in a first turn-on phase, a turn-on signal (e.g., a high-level signal in Vgl as shown in FIG. 9) may be provided to the control signal line 210, such that the switching circuit 29 may turn on the connection between the first communication signal line 221 and the compensation signal line 23; and in a first turn-off phase, a turn-off signal (e.g., a low-level signal in Vgl as shown in FIG. 9) may be provided to the control signal line 210, such that the switching circuit 29 may turn off the connection between the first communication signal line 221 and the compensation signal line 23.

The first turn-off phase may include the entire period of a communicated state. That is, in the communicated state, the connection between the first communication signal line 221 and the compensation signal line 23 (e.g., the common signal line 24) may be turned off to avoid the DC voltage stabilizing signal from impacting the communication signal on the first communication signal line 221, thereby ensuring a normal communication function.

The first turn-off phase may also include a portion of a period in a non-communicated state. That is, in the non-communicated state, the connection between the first communication signal line 221 and the compensation signal line 23 (e.g., the common signal line 24) may be turned off to avoid the DC voltage stabilizing signal from impacting the communication signal on the first communication signal line 221, thereby ensuring that the first communicational signal line 221 can achieve a function of scanning a card; and to avoid the performance deterioration caused by the first transistor T1 in the switching circuit 29 being in a turn-on state for a long time, thereby improving the performance stability of the switching circuit 29.

The first turn-on phase may include another portion of the non-communicated state. That is, in the non-communicated state, the connection between the first communication signal line 221 and the compensation signal line 23 (e.g., the common signal line 24) may be turned on to suppress a voltage offset caused by the first communication signal 221 being pulled by an external display signal etc., and then to avoid a voltage offset on the pixel electrode Ep, thereby improving the display uniformity of the display area 10.

During specific implementation, a refresh display signal may be provided to the display signal line 21 in a refresh display phase to drive the display area 10 to refresh a display screen; and a display holding signal may be provided to the display signal line 21 in a display holding phase (a Blanking period) to hold the display screen in the display area 10.

In the display holding phase, the second transistor T2 in the pixel unit P is in an off state. That is, the display signal line 21 is disconnected from the pixel electrode Ep, and the charge and discharge of the pixel electrode Ep are stopped, so that the display area 10 keeps the display screen unchanged during this period.

Correspondingly, the first turn-on phase may include a refresh display phase in the non-communicated state, and a start-end period of a display holding phase in the non-communicated state. The first turn-off phase includes an intermediate period of the display holding phase in the non-communicated state, and the whole period in the communicated state. The whole period in the communicated state includes a refresh display phase in the communicated state, and a display holding phase in the communicated state.

In the intermediate period of the display holding phase, because the display signal on the display signal line 21 is basically unchanged, the voltage fluctuation on the first communication signal line 221 caused by the display signal fluctuation is negligible. Even if the connection between the first communication signal line 221 and the compensation signal line 23 may be turned off during this period, the display uniformity of the display area 10 can also be ensured.

By controlling the first communication signal line 221 and the compensation signal line 23 to be turned on in the start-end period of the display holding phase, the voltage offset on the first communication signal line 221 and the pixel electrode Ep caused by the display signal fluctuation can be inhibited when the refresh display phase and the display holding phase are switched each other, and the display uniformity of the display area 10 is further improved.

As shown in FIG. 9, in the non-communicated state, a turn-on signal is provided to the control signal line 210 in the refresh display phase of each frame and the start-end period of the display holding phase between two frames (when the first transistor T1 is an N-type transistor, the turn-on signal is a positive voltage signal such as +12V), and at this moment, the switching circuit 29 turns on the connection between the first communication signal line 221 and the compensation signal line 23, that is, the first communication signal line 221 is communicated with a DC voltage stabilizing signal (e.g., a common voltage signal), and voltages on the first communication signal line 221 and the pixel electrode Ep are not easy to be pulled by an external signal, so that the uniform display can be ensured. In the intermediate period of the display holding phase between two frames, a turn-off signal is provided to the control signal line 210 (when the first transistor T1 is the N-type transistor, the turn-off signal is a negative voltage signal such as −12V), at this moment, the switching circuit 29 turns off the connection between the first communication signal line 221 and the compensation signal line 23, and the first communication signal line 221 is no longer communicated with the DC voltage stabilizing signal at this moment, such that a function of scanning a card is initiated only by accessing a communication signal. The next frame repeats the above process if the card is not scanned, and enters the communicated state once the card is scanned.

In the communicated state, a turn-off signal is provided to the control signal line 210 (when the first transistor T1 is the N-type transistor, the turn-off signal is a negative voltage signal such as −12V), at this moment, the switching circuit 29 turns off the connection between the first communication signal line 221 and the compensation signal line 23, and the first communication signal line 221 is no longer communicated with the DC voltage stabilizing signal at this moment, such that a communication function is initiated only by accessing a communication signal, till the communication ends and enters the non-communicated state.

In the first implementation, with the above timing control, the problem in the visibility of the first display area 101 only exists in a card swipe process, i.e., in the communicated state. However, because a screen during the card swipe process is occluded, the first display area 101 will not be seen visually.

In the second implementation, as shown in FIG. 2, the compensation signal line 23 is independently arranged. A switching circuit 29 is arranged between the first communication signal line 221 and the compensation signal line 23, and the switching circuit 29 controls the on-off between the first communication signal line 221 and the compensation signal line 23.

Because the compensation signal line 23 is a signal line independent of the common signal line 24, a common voltage signal fluctuation caused by the communication between the first communication signal line 221 and the common signal line 24 can be avoided, in order to ensure that an electric field between the common electrode Ec and the pixel electrode Ep is stable, and liquid crystal molecules cannot change rhythmically in orientation, thereby ensuring a stable display effect of the display area.

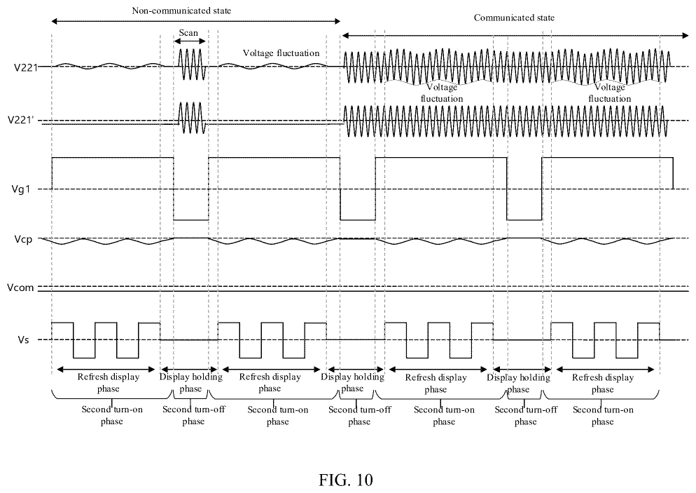

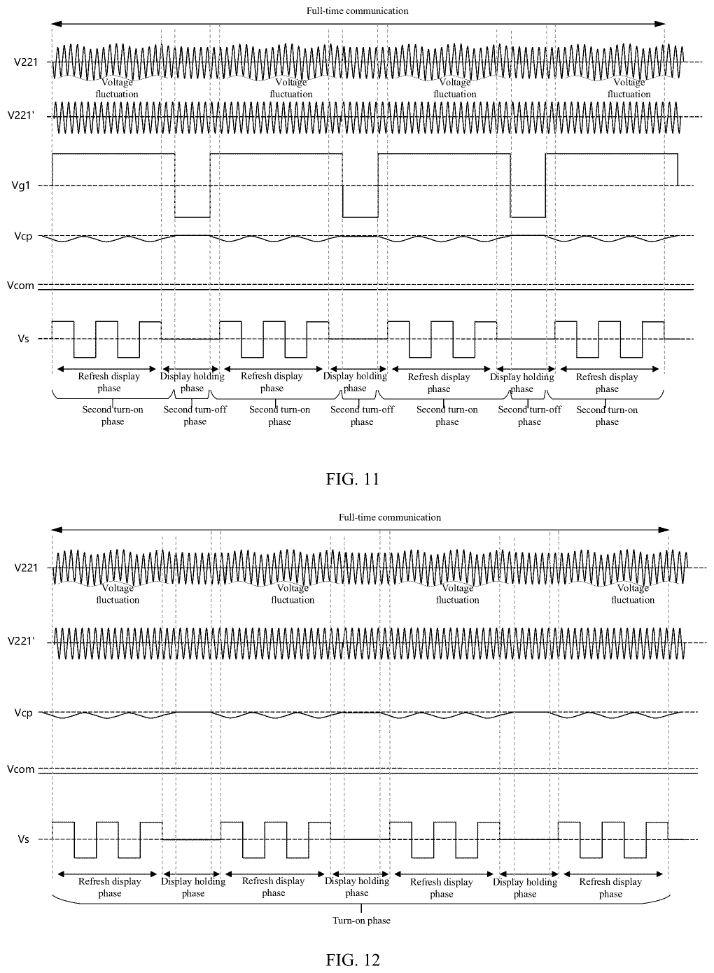

Referring to FIG. 10, a timing diagram of various signals in the second implementation is shown. This timing diagram is shown by taking the first transistor TI being an N-type transistor as an example. V211 is a voltage signal that is not compensated by the compensation signal on the first communication signal line 221; V211′ is a voltage signal that is compensated by the compensation signal on the first communication signal line 221; Vgl is a control signal on the control signal line 210; Vcp is a compensation signal on the compensation signal line 23; Vcom is a common voltage signal on the common signal line 24; and Vs is a display signal on the display signal line 21.

When the display signal on the display signal line 21 is reversed, the display signal has the greatest influence on the voltage fluctuation ΔVn on the first communication signal line 221. A voltage fluctuation ΔVn on the first communication signal line 221 fluctuates rhythmically with the row reversal of the display signal, and then the voltage on the pixel electrode Ep fluctuates with the synchronization of ΔVn. When the voltage fluctuation ΔVp on the pixel electrode Ep exceeds a defined value, the first display area 101 is macroscopically visible.

In order to reduce or eliminate the voltage fluctuation ΔVn on the first communication signal line 221, the compensation signal on the compensation signal line 23 may be an AC signal. The AC signal is opposite in phase to, but approximately equal in amplitude to the voltage fluctuation ΔVn on the first communication signal line 221. A frequency of the AC signal may be less than or equal to a scanning frequency of the display base plate, and the scanning frequency is a product of a frame refresh frequency of the display base plate and a number of rows of scanning signal lines in the display base plate.

As shown in FIG. 10, in a second turn-on phase, a turn-on signal (e.g., a high-level signal in Vgl as shown in FIG. 10) may be provided to the control signal line 210, such that the switching circuit 29 may turn on the connection between the first communication signal line 221 and the compensation signal line 23; and in a second turn-off phase, a turn-off signal (e.g., a low-level signal in Vgl as shown in FIG. 10) may be provided to the control signal line 210, such that the switching circuit 29 may turn off the connection between the first communication signal line 221 and the compensation signal line 23.

During specific implementation, a refresh display signal may be provided to the display signal line 21 in the refresh display phase to drive the display area 10 to refresh a display screen;

and a display holding signal may be provided to the display signal line 21 in the display holding phase (a Blanking period) to hold the display screen in the display area 10.

The second turn-on phase may include a start-end period of the refresh display phase and the display holding phase; and the second turn-off phase may include an intermediate period of the display holding phase.

The switching circuit 29 turns on the connection between the first communication signal line 221 and the compensation signal line 23 in the start-end period of the refresh display phase and the display holding phase, such that a voltage offset caused by the first communication signal 221 being pulled by a display signal etc. can be compensated or offset to reduce the voltage offset on the pixel electrode Ep, thereby improving the display uniformity of the display area 10.

The switching circuit 29 turns off the connection between the first communication signal line 221 and the compensation signal line 23 in the intermediate period of the display holding phase, such that the performance deterioration caused by the first transistor T1 in the switching circuit 29 being in a turn-on state for a long time can be avoided, thereby improving the performance stability of the switching circuit 29.

In the second implementation, in the intermediate period of the display holding phase, because the display signal on the display signal line 21 is basically unchanged, the voltage fluctuation on the first communication signal line 221 caused by the display signal fluctuation is negligible. Even if the connection between the first communication signal line 221 and the compensation signal line 23 may be turned off during this period, the display uniformity of the display area 10 can also be ensured.

By controlling the first communication signal line 221 and the compensation signal line 23 to be turned on in the start-end period of the display holding phase, the voltage offset on the first communication signal line 221 and the pixel electrode Ep caused by the display signal fluctuation can be inhibited when the refresh display phase and the display holding p are switched each other, and the display uniformity of the display area 10 is further improved.

As shown in FIG. 10, a turn-on signal is provided to the control signal line 210 in the refresh display phase of each frame and the start-end period of the display holding phase between two frames (when the first transistor T1 is an N-type transistor, the turn-on signal is a positive voltage signal such as +12V), and at this moment, the switching circuit 29 turns on the connection between the first communication signal line 221 and the compensation signal line 23, that is, the first communication signal 221 is communicated with the compensation signal, the voltage fluctuation ΔVn on the first communication signal line 221 is compensated (if the compensation signal is opposite in phase and unequal in amplitude to the voltage fluctuation ΔVn) or offset (if the compensation signal is opposite in phase but equal in amplitude to the voltage fluctuation ΔVn), and the voltage pull on the pixel electrode Ep is reduced, so that the uniform display can be ensured. In the intermediate period of the display holding phase between two frames, a turn-off signal is provided to the control signal line 210 (when the first transistor T1 is the N-type transistor, the turn-off signal is a negative voltage signal such as −12V), at this moment, the switching circuit 29 turns off the connection between the first communication signal line 221 and the compensation signal line 23, and the first communication signal line 221 is no longer communicated with the compensation signal at this moment, while a communication signal is accessed only.

In the second turn-off phase in the non-communicated state, the first display area can achieve a function of scanning a card. The non-communicated state is still kept when the card is not scanned, while the communicated state is entered once the card is scanned. In the second turn-off phase and the second turn-on phase in the communicated state, the first display area can achieve a communication function, till the communication ends and enters the non-communicated state.

In the second implementation, with the above timing control, the problem in the visibility of the first display area 101 can be improved in both the communicated state and the non-communicated state, and the voltage offset on the first communication signal line 221 and the pixel electrode Ep can be completely suppressed, thereby improving the display uniformity of the display area 10.

It should be noted that the timing diagram of various signals in the second implementation may also be shown in FIG. 11. In FIG. 10, a non-full-time communication scheme is adopted, that is, a high-frequency communication signal is provided to the first communication signal line 221 only in the intermediate period of the display holding phase in the non-communicated state and in the entire communicated state. In FIG. 11, a full-time communication scheme is adopted, that is, a high-frequency communication signal is provided to the first communication signal line 221 uninterruptedly in the entire communicated state and non-communicated state.

In the third implementation, as shown in FIG. 5, the first communication signal line 221 is directly communicated with the compensation signal line 23, both of which are kept in the communicated state since the switching circuit 29 is not required to control the on-off therebetween.

Referring to FIG. 12, a timing diagram of various signals in the third implementation is shown. V211 is a voltage signal that is not compensated by a compensation signal on the first communication signal line 221; V211′ is a voltage signal that is compensated by the compensation signal on the first communication signal line 221; Vcp is a compensation signal on the compensation signal line 23; Vcom is a common voltage signal on the common signal line 24; and Vs is a display signal on the display signal line 21.

When the display signal on the display signal line 21 is reversed, the display signal has the greatest influence on the voltage fluctuation ΔVn on the first communication signal line 221. A voltage fluctuation & Vn on the first communication signal line 221 fluctuates rhythmically with the row reversal of the display signal, and then the voltage on the pixel electrode Ep fluctuates with the synchronization of ΔVn. When the voltage fluctuation ΔVp on the pixel electrode Ep exceeds a defined value, the first display area 101 is macroscopically visible.

In order to reduce or eliminate the voltage fluctuation ΔVn on the first communication signal line 221, the compensation signal on the compensation signal line 23 may be an AC signal. The AC signal is opposite in phase to, but approximately equal in amplitude to the voltage fluctuation ΔVn on the first communication signal line 221. A frequency of the AC signal may be less than or equal to a scanning frequency of the display base plate, and the scanning frequency is a product of a frame refresh frequency of the display base plate and a number of rows of scanning signal lines in the display base plate.

During specific implementation, a compensation signal 23 that is opposite in phase to the voltage fluctuation ΔVn on the first communication signal line 221 is provided to the compensation signal line 23, and the first communication signal line 221 and the compensation signal line 23 are kept in a turn-on state. In this way, a voltage offset caused by the first communication signal line 221 being pulled by an external display signal etc. can be compensated or offset to reduce the voltage offset on the pixel electrode Ep, thereby improving the display uniformity of the display area 10.

In this implementation, since the first communication signal line 221 and the compensation signal line 23 are kept in a turn-on state, the problem in the visibility of the first display area 101 can be improved in both the communicated state and the non-communicated state, and the voltage offset on the first communication signal line 221 and the pixel electrode Ep can be completely suppressed, thereby improving the display uniformity of the display area 10.

As shown in FIG. 11, since the first communication signal line 221 and the compensation signal line 23 are kept connected, the first communication signal line 221 is always communicated with the compensation signal, and then the voltage fluctuation ΔVn on the first communication signal line 221 is compensated (e.g., the compensation signal is opposite in phase and unequal in amplitude to the voltage fluctuation ΔVn) or offset (e.g., the compensation signal is opposite in phase but equal in amplitude to the voltage fluctuation ΔVn), and the voltage pull on the pixel electrode Ep is reduced, thereby ensuring the uniform display.

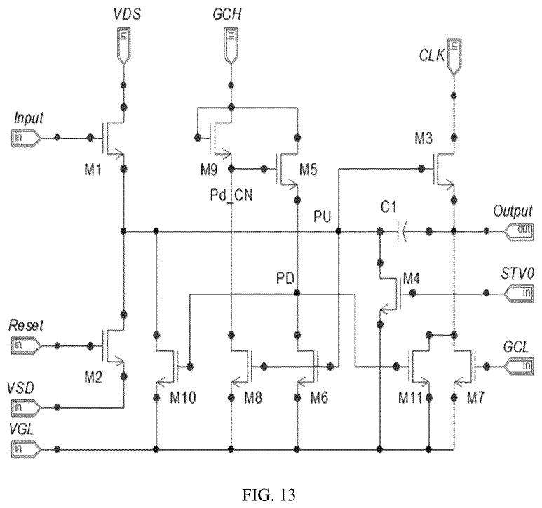

In some implementations, the GOA circuit 111 may adopt an 11TIC circuit. Referring to FIG. 13, a schematic diagram of a connecting structure of the 11TIC circuit is shown. The 11TIC circuit includes eleven transistors (M1 to M11 as shown in FIG. 13) and a capacitor (C1 as shown in FIG. 13).

The present disclosure further provides a display apparatus. The display apparatus includes the display base plate as provided by any of the implementations; a driving circuit, configured to provide driving signals to the display base plate, the driving signals including the display signal, the communication signal and the compensation signal; and a power supply circuit, configured to provide a power supply to the display base plate.

Those skilled in the art may understand that this display apparatus has the advantages of a front display base plate.

The display apparatus is a product with an image display function. For example, the display apparatus may be: a display, a television, a billboard, a digital photo frame, a laser printer with a display function, a telephone, a mobile phone, a personal digital assistant (PDA), a digital camera, a portable camcorder, a viewfinder, a navigator, a vehicle, a large-area wall, a home appliance, an information inquiry device (e.g., a business inquiry device for e-government, banks, hospitals, electric power and other departments), a monitor and the like. The display apparatus may also be a microdisplay or a product that includes a microdisplay. The product that includes the microdisplay may be any of a smart watch, a smart bracelet, a head-mounted display, a stereoscopic display mirror, an AR device (e.g., AR glasses), or a VR device (e.g., VR glasses).

The present disclosure provides a driving method for a displaying base plate, applied to the display base plate as provided by any one of the implementations. This driving method includes:

Step S21: providing a display signal to the display signal line 21 to drive the display area 10 to display a screen;

Step S22: providing a communication signal to the first communication signal line 221, such that the first communication signal line 221 transmits the communication signal; and

Step S23: providing a compensation signal to the compensation signal line 23, such that

the compensation signal is transmitted to the first communication signal line 221, to suppress a voltage fluctuation on the first communication signal line 221 caused by a display signal fluctuation on the display signal line 21 and a coupling capacitance.

In some implementations, the compensation signal is a DC voltage stabilizing signal. Exemplarily, this DC voltage stabilizing signal may be a common voltage signal.

In some implementations, in Step S21, the step of providing the display signal to the display signal line 21 includes:
in a refresh display phase, providing a refresh display signal to the display signal line 21 to drive the display area 10 to refresh a display screen; and
in a display holding phase, providing a display holding signal to the display signal line 21, such that the display area 10 holds the display screen.

In some implementations, in the cases where the display base plate further includes a switching circuit 29 and the switching circuit 29 is respectively connected to the control signal line 210, the first communication signal line 221 and the compensation signal line 23, after Step S23, the driving method may further include:

Steps S31: in a first turn-on phase, providing a turn-on signal to the control signal line 210, such that the switching circuit 29 turns on the connection between the first communication signal line 221 and the compensation signal line 23; and

Steps S32: in a first turn-off phase, providing a turn-off signal to the control signal line 210, such that the switching circuit 29 turns off the connection between the first communication signal line 221 and the compensation signal line 23.

As shown in FIG. 9, the first turn-on phase includes a refresh display phase in the non-communicated state, and a start-end period of the display holding phase in the non-communicated state; and the first turn-off phase includes an intermediate period of the display holding phase in the non-communicated state, a refresh display phase in the communicated state, and a display holding phase in the communicated state.

In some implementations, the compensation signal is an AC signal, and the AC signal is opposite in phase to the voltage fluctuation.

In some implementations, the AC signal is equal in amplitude to the voltage fluctuation.

In some implementations, a frequency of the compensation signal may be less than or equal to a scanning frequency of the display base plate, and the scanning frequency is a product of a frame refresh frequency of the display base plate and a number of rows of scanning signal lines in the display base plate.

In some implementations, in the cases where the display base plate further includes a

switching circuit 29 and the switching circuit 29 is respectively connected to the control signal line 210, the first communication signal line 221 and the compensation signal line 23, after Step S23, the driving method may further include:

Steps S41: in a second turn-on phase, providing a turn-on signal to the control signal line 210, such that the switching circuit 29 turns on the connection between the first communication signal line 221 and the compensation signal line 23; and

Steps S42: in a second turn-off phase, providing a turn-off signal to the control signal line 210, such that the switching circuit 29 turns off the connection between the first communication signal line 221 and the compensation signal line 23.

As shown in FIG. 10 or FIG. 11, the second turn-on phase may include a start-end period of the refresh display phase and the display holding phase; and the second turn-off phase may include an intermediate period of the display holding phase.

During specific implementation, the amplitude of the compensation signal is related to the display screen, and the corresponding compensation signal changes dynamically as the display base plate displays different screens. The compensation signal may be determined according to a display signal on a display data line, a coupling capacitance and other factors, which will be specifically limited in the present disclosure.

During specific implementation, the compensation signal may also be an AC signal that is the same in phase as a voltage fluctuation, the amplitudes of which may be equal or unequal. In a case where the compensation signal is the same in phase as the voltage fluctuation, a voltage fluctuation amplitude on the first communication signal line 221 can be increased, then a voltage fluctuation amplitude on the pixel electrode Ep can be increased, and a display difference between the first display area 101 and the second display area 102 can be increased, such that the first display area 101 is clearly visible when needed. For example, the macro visibility of the first display area 101 can be improved at a time when a card approaches to the display base plate, allowing a user to visually see a coil position.

In some implementations, as shown in any one of FIG. 9 to FIG. 12, the communication signal includes a high-frequency signal, wherein a frequency of the high-frequency signal may be greater than a scanning frequency of the display base plate, and the scanning frequency is a product of a frame refresh frequency of the display base plate and a number of rows of scanning signal lines in the display base plate.

For example, the frequency of the high-frequency signal may be in a megahertz level. Since liquid crystal molecules cannot respond effectively to such a high-frequency signal, the influence of the high-frequency signal in the communication signal on a display effect is negligible.

In some implementations, as shown in FIG. 9 or FIG. 10, in Step S22, the step of providing the communication signal to the first communication signal line 221 includes:

in the intermediate period of the display holding phase in the non-communicated state, the refresh display phase in the communicated state, and the display holding phase in the communicated state, providing the high-frequency signal to the first communication signal line 221.

In this implementation, a non-full-time communication scheme is adopted. A high-frequency signal is not provided to the first communication signal line 221 in the start-end period of the display holding phase in the non-communicated state and the refresh display phase in the non-communicated state; and a high-frequency signal is provided to the first communication signal line 221 only in the intermediate period of the display holding phase in the non-communicated state, the refresh display phase in the communicated state, and the display holding phase in the communicated state. The non-full-time communication scheme may be adopted to improve a display effect.

In some implementations, as shown in FIG. 11 or FIG. 12, in Step S22, the step of providing the communication signal to the first communication signal line 221 includes:

in the refresh display phase and the display holding phase, providing the high-frequency signal to the first communication signal line 221.

In this implementation, a full-time communication scheme is adopted, that is, a high-frequency communication signal is provided to the first communication signal line 221 uninterruptedly in the refresh display phase and the display holding phase in the communicated state, and the refresh display phase and the display holding phase in the non-communicated state. The full-time communication scheme may be adopted to improve the sensitivity of a communication function.

It should be noted that when the compensation signal is a DC voltage stabilizing signal, the non-full-time communication scheme may be used to ensure that the communication function will not be affected by the DC voltage stabilizing signal.

It should be noted that this driving method may also include more steps, which may be determined according to actual needs, and will not be limited in the present disclosure. The detailed description of the driving method and the technical effect may refer to the description of the display base plate above, which will not be repeated here.

In the present disclosure, unless otherwise stated specifically, the term “a plurality of” means two or more, and the term “at least one” means one or more.

In the present disclosure, the orientation or position relations indicated via terms of “upper”, “lower” and the like are based on orientation or the position relations shown in the drawings only to describe the present disclosure conveniently and simplify the description, but not indicate or imply that referred apparatuses or elements must have particular orientations or be constructed and operated with the particular orientation, so that they cannot be construed as limiting of the present disclosure.

The terms “include”, “contain” or any variation thereof herein are intended to cover a

nonexclusive containing, such that a process, a method, an item or a device containing a series of elements not only includes these elements, but also includes other elements that are not set forth specifically, or also includes an inherent element of such a process, method, product or device. Without further limitation, an element defined by a phrase “include a . . . ” does not mean that other elements are excluded from the process, method, item or device including the same element.

The terms herein such as “an embodiment”, “some embodiments”, “an exemplary embodiment”, “one or more embodiments”, “an example”, “a specific example” and “some examples” are intended to indicate that particular features, structures, materials or characteristics described in association with the embodiments or examples are included in at least one embodiment or example of the present disclosure. The schematic description of the above terms does not necessarily refer to the same embodiment or example. Furthermore, the described particular features, structures, materials or characteristics may be included in any one or more embodiments or examples in a proper manner.

Relation terms herein such as “first” and “second” are used merely to distinguish a subject or an operation from another subject or another operation, but not necessarily to imply any substantial relation or order between these subjects or operations.

In the description of some embodiments, the expressions “coupled” and “connected”

may be used. For example, the term “connected” may be used in some embodiments to indicate that two or more components are in direct physical or electrical contact with each other. For another example, the term “coupled” may be used in some embodiments to indicate that two or more components are in direct physical or electrical contact with each other. However, the term “coupled” or “communicatively coupled” may also refer that two or more components are not in direct contact with each other, but still cooperate or interact with each other. The embodiments disclosed herein are not necessarily limited to the content of the present disclosure.

“At least one of A, B and C” has the same meaning as “at least one of A, B or C”, both of which include the following combinations of A, B and C: A alone, B alone and C alone, a combination of A and B, a combination of A and C, a combination of B and C, and a combination of A, B and C.

“A and/or B” includes the following three combinations: A alone, B alone, and a combination of A and B.

As used herein, depending on the context, the term “if” is optionally interpreted to mean “when . . . ” or “at the moment of . . . ”, or “in response to determining . . . ” or “in response to detecting . . . ”. Similarly, depending on the context, the phrase “if the. is determined” or “if [the stated condition or event] is detected” is optionally interpreted to mean “at the moment of determining . . . ” or “in response to determining . . . ” or “when [the stated condition or event] is detected” or “in response to detecting [the stated condition or event]”.

The use of “used to” or “configured to” herein means an open and inclusive language

that does not exclude devices that apply to or are configured to perform additional tasks or steps.

The use of “based on” or “according to” herein implies openness and inclusiveness. A process, step, calculation, or other action based on one or more of the conditions or values may in practice be based on other conditions or exceed the stated values. A process, step, calculation, or other action based on one or more of the conditions or values may in practice be based on other conditions or exceed the stated values.

As used herein, “about”, “roughly” or “approximately” includes the stated values and average values that fall within an acceptable deviation range of particular values. The acceptable deviation range is determined by a person of ordinary skill in the art taking into account the measurement in question and an error associated with the measurement of a particular amount (i.e., the limitation of a measurement system).

As used herein, “parallel”, “perpendicular”, “equal” and “flush” include the stated case and a case similar to the stated case. The range of the similar case is within an acceptable deviation range. The acceptable deviation range is determined by a person of ordinary skill in the art taking into account the measurement in question and an error associated with the measurement of a particular amount (i.e., the limitation of a measurement system). For example, “parallel” includes absolute parallelism and approximate parallelism, where an acceptable deviation range of the approximate parallelism may, for example, be within 5°; and “perpendicular” includes absolute perpendicularity and approximate perpendicularity, where an acceptable deviation range of the approximate perpendicularity may be, for example, within 5°. “Equal” includes absolute equality and approximate equality, where an acceptable deviation range of the approximate equality may, for example, indicate that a difference between two same parts is less than or equal to 5% of either one. “Flush” includes absolute flushness and approximate flushness, where an acceptable deviation range of the approximate flushness may, for example, indicate that a distance between two flush parts is less than or equal to 5% of either one.

It should be understood that when a layer or element is referred to be on another layer or base plate, it may mean that layer or element is directly on the other layer or base plate, or it may also mean that there is an intermediate layer between that layer or element and the another layer or base plate.

An exemplary implementation is described with reference to a sectional view and/or planar view as an idealized exemplary drawing. In drawings, for clarity of illustration, the thickness of the layers and regions may be scaled up. Therefore, changes in the shapes of the drawings due to, for example, manufacturing techniques and/or tolerances, may be envisaged. Therefore, the exemplary implementation should not be construed as confined to the shape of an area shown herein, but rather include deviations in shape resulting from, for example, manufacturing. For example, an etched area shown as a rectangle will typically have a curved character. Therefore, the areas shown in the drawings are schematic in nature, and their shapes are not intended to illustrate the actual shapes of the areas of the device, and are not intended to limit the scope of the exemplary implementation.

It should be eventually noted that the above embodiments are only used to illustrate the technical solutions of the present disclosure and are not intended to limit the present disclosure. Although the present disclosure has been described in detail with reference to the foregoing embodiments, those of ordinary skills in the art should understand that, they can still make modifications to the technical solutions described in the foregoing embodiments or make equivalent substitutions to some of the technical features; and these modifications or substitutions do not make the essence of the corresponding technical solutions deviate from the spirit and scope of the technical solutions of the various embodiments of the present disclosure.

1. A display base plate, comprising a display area and a border area located on at least one side of the display area, the display area comprising a first display area and a second display area, and the display base plate comprising:
a substrate, and a display signal line, a communication signal line and a compensation signal line located on at least one side of the substrate, wherein
the display signal line is configured to transmit a display signal to a pixel unit of the display area;
the communication signal line is coupled with the display signal line to form a coupling capacitance, and comprises a first communication signal line, at least part of the first communication signal line is located in the first display area, and the first communication signal line is configured to transmit a communication signal; and
the compensation signal line is located in the border area, is connected to the first communication signal line and is configured to transmit a compensation signal to the first communication signal line, and the compensation signal is configured to suppress a voltage fluctuation on the first communication signal line caused by a display signal fluctuation on the display signal line and the coupling capacitance.

2. The display base plate according to claim 1, wherein the compensation signal line is independently arranged.

3. The display base plate according to claim 1, wherein the display base plate further comprises:
a common signal line, located in the border area and is configured to transmit a common voltage signal to a common electrode of the pixel unit, and the plurality of pixel units share the common electrode, wherein
the common signal line is multiplexed as the compensation signal line.

4. The display base plate according to claim 1, wherein the display base plate further comprises:
a switching circuit, located on the border area, wherein a first terminal of the switching circuit is connected to a control signal line, a second terminal of the switching circuit is connected to the first communication signal line, and a third terminal of the switching circuit is connected to the compensation signal line; and the switching circuit is configured to turn on or off the connection between the first communication signal line and the compensation signal line according to a control signal inputted by the control signal line.

5. The display base plate according to claim 4, wherein the switching circuit comprises:
a first transistor, wherein a control electrode is connected to the control signal line, a first electrode is connected to the compensation signal line, and a second electrode is connected to the first communication signal line.

6. The display base plate according to claim 4, wherein the pixel unit comprises:
a second transistor, wherein a control electrode is connected to a scanning signal line, a first electrode is connected to the display signal line, and a second electrode is connected to a pixel electrode of the pixel unit; and the second transistor is configured to control the on-off between the display signal line and the pixel electrode according to a scanning signal inputted by the scanning signal line; and
the display base plate further comprises:
a GOA circuit, located in the border area, is connected to the scanning signal line and is configured to output the scanning signal to the scanning signal line, wherein
the switching circuit is located on one side of the GOA circuit close to the display area, and the compensation signal line is located on one side of the switching circuit close to the display area.

7. The display base plate according to claim 1, wherein the display base plate comprises two compensation signal lines, the two compensation signal lines are a first compensation signal line and a second compensation signal line, and the first compensation signal line and the second compensation signal line are respectively located on two opposite sides of the display area in a row direction; and
among a plurality of first communication signal lines that extends in the row direction and are arranged in a column direction, the first communication signal lines located in each row are connected to the first compensation signal line and the second compensation signal line respectively.

8. The display base plate according to claim 1, wherein the display base plate comprises two compensation signal lines, the two compensation signal lines are a first compensation signal line and a second compensation signal line, and the first compensation signal line and the second compensation signal line are respectively located on two opposite sides of the display area in the row direction; and
among the plurality of first communication signal lines that extends in the row direction and are arranged in the column direction, the first communication signal lines located in odd-numbered rows are connected to the first compensation signal line, and the first communication signal lines located in even-numbered lines are connected to the second compensation signal line.

9. The display base plate according to claim 1, wherein the display base plate further comprises:
a communication signal input terminal, located on the border area, is connected to the first communication signal line and is configured to provide the communication signal to the first communication signal line, wherein
the communication signal input terminal is multiplexed as the compensation signal line.

10. The display base plate according to claim 1, wherein the display base plate further comprises a common signal line, located in the border area and is configured to transmit a common voltage signal to the common electrode of the pixel unit, and the plurality of pixel units share the common electrode, wherein the communication signal line further comprises a second communication signal line, and at least part of the second communication signal line is located in the second display area; and wherein the second communication signal line is connected to the common signal line.

11. A display apparatus, comprising:
the display base plate according to claim 1;
a driving circuit, configured to provide driving signals to the display base plate, the driving signals comprising the display signal, the communication signal and the compensation signal; and
a power supply circuit, configured to provide a power supply to the display base plate.

12. A driving method for a displaying base plate, applied to the display base plate according to claim 1, the driving method comprising:
providing a display signal to the display signal line to drive the display area to display a screen;
providing a communication signal to the first communication signal line, such that the first communication signal line transmits the communication signal; and
providing a compensation signal to the compensation signal line, such that the compensation signal is transmitted to the first communication signal line, to suppress a voltage fluctuation on the first communication signal line caused by a display signal fluctuation on the display signal line and the coupling capacitance.

13. The driving method according to claim 12, wherein the compensation signal is a DC voltage stabilizing signal.

14. The driving method according to claim 13, wherein the step of providing the display signal to the display signal line comprises:
in a refresh display phase, providing a refresh display signal to the display signal line to drive the display area to refresh a display screen; and
in a display holding phase, providing a display holding signal to the display signal line, such that the display area holds the display screen; and
in the cases where the display base plate further comprises a switching circuit and the switching circuit is respectively connected to a control signal line, the first communication signal line and the compensation signal line, after the step of providing the compensation signal to the compensation signal line, the driving method further comprises:
in a first turn-on phase, providing a turn-on signal to the control signal line, such that the switching circuit turns on the connection between the first communication signal line and the compensation signal line; and
in a first turn-off phase, providing a turn-off signal to the control signal line, such that the switching circuit turns off the connection between the first communication signal line and the compensation signal line, wherein
the first turn-on phase comprises: a refresh display phase in a non-communicated state, and a start-end period of the display holding phase in the non-communicated state; and
the first turn-off phase comprises: an intermediate period of the display holding phase in the non-communicated state, a refresh display phase in a communicated state, and a display holding phase in the communicated state.

15. The driving method according to claim 12, wherein the compensation signal is an AC signal, and the AC signal is opposite in phase to the voltage fluctuation.

16. The driving method according to claim 15, wherein the AC signal is equal in amplitude to the voltage fluctuation.

17. The driving method according to claim 15, wherein a frequency of the compensation signal is less than or equal to a scanning frequency of the display base plate, and the scanning frequency is a product of a frame refresh frequency of the display base plate and a number of rows of scanning signal lines in the display base plate.

18. The driving method according to claim 15, wherein the step of providing the display signal to the display signal line comprises:
in a refresh display phase, providing a refresh display signal to the display signal line to drive the display area to refresh a display screen; and
in a display holding phase, providing a display holding signal to the display signal line, such that the display area holds the display screen; and
in the cases where the display base plate further comprises a switching circuit and the switching circuit is respectively connected to a control signal line, the first communication signal line and the compensation signal line, after the step of providing the compensation signal to the compensation signal line, the driving method further comprises:
in a second turn-on phase, providing a turn-on signal to the control signal line, such that the switching circuit turns on the connection between the first communication signal line and the compensation signal line; and
in a second turn-off phase, providing a turn-off signal to the control signal line, such that the switching circuit turns off the connection between the first communication signal line and the compensation signal line, wherein
the second turn-on phase comprises a start-end period of the refresh display phase and the display holding phase; and
the second turn-off phase comprises: an intermediate period of the display holding phase.

19. The driving method according to claim 12, wherein the communication signal comprises a high-frequency signal, a frequency of the high-frequency signal is greater than a scanning frequency of the display base plate, and the scanning frequency is a product of a frame refresh frequency of the display base plate and a number of rows of scanning signal lines in the display base plate.

20. The driving method according to claim 19, wherein the step of providing the display signal to the display signal line comprises:
in a refresh display phase, providing a refresh display signal to the display signal line to drive the display area to refresh a display screen; and
in a display holding phase, providing a display holding signal to the display signal line, such that the display area holds the display screen; and
the step of providing the communication signal to the first communication signal line comprises:
in the refresh display phase and the display holding phase, providing the high-frequency signal to the first communication signal line; or
in the intermediate period of the display holding phase in the non-communicated state, the refresh display phase in the communicated state, and the display holding phase in the communicated state, providing the high-frequency signal to the first communication signal line.
